(19) United States
(12) Patent Application Publication
(10) Pub. No.: US 2025/0063966 A1
(43) Pub. Date: Feb. 27, 2025

(54) STRIP CONDITIONER FOR A ROW UNIT OF AN AGRICULTURAL IMPLEMENT

(71) Applicant: CNH Industrial America LLC, New Holland, PA (US)

(72) Inventors: Austin Joseph Lewandowski, Congerville, IL (US); Brian Michael Craig, Congerville, IL (US)

(21) Appl. No.: 18/807,269

(22) Filed: Aug. 16, 2024

Related U.S. Application Data
(60) Provisional application No. 63/578,019, filed on Aug. 22, 2023.

(51) Int. Cl. A01B 27/00; A01B 15/16; A01B 35/28; A01B 49/02

(52) U.S. Cl. CPC A01B 27/005; A01B 15/16; A01B 35/28; A01B 49/027

(57) ABSTRACT

A strip conditioner for an agricultural row unit includes a conditioner frame configured to be supported relative to a row unit, and a rotary tool assembly coupled to the conditioner frame for rotation relative thereto, with the rotary tool assembly including a plurality of cultivator wheels. The strip conditioner further includes a rake assembly supported by the conditioner frame relative to the rotary tool assembly. The rake assembly includes a rod support member coupled to the conditioner frame, and a plurality of rake rods coupled to the rod support member. Each rake rod extends from the rod support member to a location between a respective pair of adjacent cultivator wheels of the plurality of cultivator tools. Additionally, each rake rod of the plurality of rake rods defines a circular cross-sectional shape.

### CROSS-REFERENCE TO RELATED APPLICATIONS

The present application is based upon and claims the right of priority to U.S. Provisional Patent Application No. 63/578,019, filed Aug. 22, 2023, the disclosure of which is hereby incorporated by reference herein in its entirety for all purposes.

### FIELD OF THE INVENTION

The present subject matter relates generally to agricultural implements, such as strip tillage implements and, more particularly, to a strip conditioner configured for use with a row unit for an agricultural implement.

### BACKGROUND OF THE INVENTION

Many agricultural implements include row units for processing a narrow strip of soil during the performance of an agricultural operation. For instance, planters include planter row units for opening a furrow along a narrow strip of soil, depositing a seed within the furrow, and then subsequently closing the furrow. Similarly, strip-tillage implements include strip-tillage row units for tilling a narrow strip of soil to prepare the soil for subsequent planting.

In many instances, row units may include a finishing tool positioned at the aft end of the row unit for performing a finishing operation on the soil previously worked by the upstream ground-engaging tools of the row unit. For example, a strip-tillage row unit may often include a strip conditioner, such as a cultivator, positioned at the aft end of the row unit that includes cultivator wheels for breaking up soil clods and/or performing any other finishing-related functions. However, such conditioners are often subject to plugging. For instance, mud, residue, and/or other field materials will often accumulate between adjacent cultivator wheels of the strip conditioner, thereby leading to plugging.

Accordingly, an improved strip conditioner that addresses one or more of the relevant issues in the prior art would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a strip conditioner for an agricultural row unit. The strip conditioner includes a conditioner frame configured to be supported relative to a row unit, and a rotary tool assembly coupled to the conditioner frame for rotation relative thereto. The rotary tool assembly comprises a plurality of cultivator wheels. The strip conditioner further includes a rake assembly supported by the conditioner frame relative to the rotary tool assembly. The rake assembly includes a rod support member coupled to the conditioner frame, and a plurality of rake rods coupled to the rod support member. Each rake rod extends from the rod support member to a location between a respective pair of adjacent cultivator wheels of the plurality of cultivator tools. Additionally, each rake rod of the plurality of rake rods defines a circular cross-sectional shape.

In another aspect, the present subject matter is directed to an agricultural row unit. The row unit includes a main frame, a plurality of ground-engaging tools coupled to the main frame, and an aft frame assembly coupled to the main frame and extending outwardly therefrom to an aft end of the aft frame assembly. Additionally, the row unit includes a strip conditioner supported relative to the aft frame assembly. The strip conditioner includes a conditioner frame coupled to the aft end of the aft frame assembly and a rotary tool assembly coupled to the conditioner frame for rotation relative thereto. The rotary tool assembly includes a plurality of rotary tools, with the plurality of rotary tools including first and second gauge wheels and a plurality of cultivator wheels spaced apart from one another between the first and second gauge wheels. The strip conditioner further includes a rake assembly supported by the conditioner frame relative to the rotary tool assembly. The rake assembly includes a rod support member coupled to the conditioner frame and a plurality of rake rods coupled to the rod support member, with each rake rod extending from the rod support member to a location between a respective pair of adjacent rotary tools of the plurality of rotary tools. Additionally, each rake rod of the plurality of rake rods defines a circular cross-sectional shape.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of an agricultural implement in accordance with aspects of the present subject matter;

FIG. 2 illustrates a side view of one embodiment of a row unit suitable for use with the implement shown in FIG. 1 in accordance with aspects of the present subject matter;

FIG. 3 illustrates a perspective view of one embodiment of a strip conditioner suitable for use with the row unit shown in FIG. 2 in accordance with aspects of the present subject matter;

FIG. 4 illustrates a side view of the strip conditioner shown in FIG. 3; and

FIG. 5 illustrates a rear view of the strip condition shown in FIG. 3.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a strip conditioner for an agricultural row unit. In several embodiments, the strip conditioner includes both a rotary tool assembly and a rake assembly. The rotary tool assembly generally includes a plurality of rotary tools for performing a finishing operation at the aft end of the row unit. For instance, the rotary tool assembly may include a plurality of cultivator wheels (e.g., spider wheels) configured to break apart soil clods. Additionally, the rake assembly may include a plurality of rake rods configured to prevent plugging of the rotary tool assembly. For instance, the rake rods may be configured to extend between adjacent rotary tools of the rotary tool assembly to allow the rods to break apart and clear away soil, residue, debris, and any other field materials that flow or are directed between the adjacent tools. In this regard, in accordance with aspects of the present subject matter, each rake rod may be configured to define a circular cross-sectional shape that allows for the field materials to flow more freely through the gaps defined between the rake rods and any adjacent rotary tools. For instance, the circular cross-sectional shape of each rake rod is free from sharp edges that would otherwise catch or hold-up field materials flowing between the adjacent rotary tools.

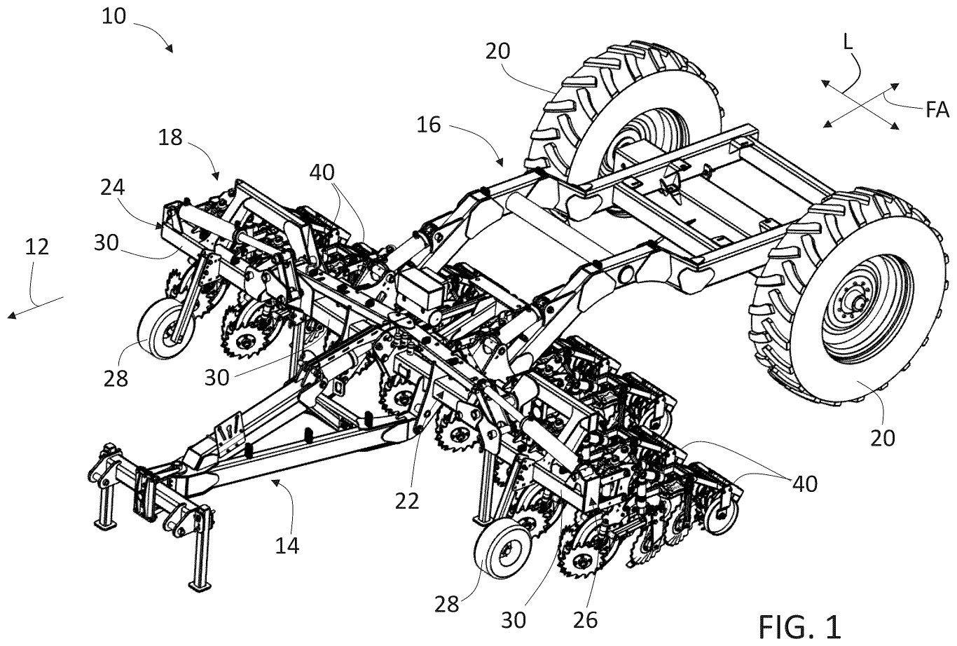

Referring now to the drawings, FIG. 1 illustrates a perspective view of one embodiment of an agricultural implement 10 in accordance with aspects of the present subject matter. In general, the implement 10 may be configured to be towed across a field in a forward direction of travel (e.g., as indicated by arrow 12 in FIG. 1) by a work vehicle (e.g., an agricultural tractor). As shown, the implement 10 is configured as a strip tillage implement. However, in other embodiments, the implement 10 may be configured as any other suitable type of implement, such as a seed-planting implement, a fertilizer-dispensing implement, and/or the like.

As shown in FIG. 1, the implement 10 includes a towbar assembly 14, a chassis assembly 16, and a toolbar assembly 18. As is generally understood, the towbar assembly 14 may be configured to allow the implement 10 to be coupled to a tow vehicle (e.g., a tractor) for towing the implement 10 along a field during the performance of a strip-tillage operation. For instance, the towbar assembly 14 may incorporate a hitch or other suitable coupling for connecting the implement 10 to a tow vehicle. In one embodiment, the chassis assembly 16 may be configured to support one or more storage tanks (not shown). For instance, the storage tank(s) may correspond to a fertilizer tank or any other suitable type of storage tank configured to store an agricultural material. Additionally, the chassis assembly 16 may be coupled to one or more pairs of chassis support wheels 20. For example, as shown in FIG. 1, a pair of support wheels 20 are coupled to the aft end of the chassis assembly 16 to support the implement 10 relative to the ground.

It should be appreciated that, in the illustrated embodiment, the chassis assembly 16 is positioned at the aft end of the implement 10 such that the toolbar assembly 18 is disposed between the towbar assembly 14 and the chassis assembly 16 along the fore-aft direction of the implement 10 (as indicated by arrow FA in FIG. 1). For instance, as shown in FIG. 1, toolbar assembly 18 is pivotably coupled at its forward end to the towbar assembly 14 and at its aft end to the chassis assembly 16. Alternatively, the chassis assembly 16 may be positioned between the towbar assembly 14 and the toolbar assembly 18 in the fore-aft direction FA of the implement 10 such that the toolbar assembly 18 is disposed at the aft end of the implement 10. In such an embodiment, the forward end of the toolbar assembly 18 may be coupled to the aft end of the chassis assembly 16 (e.g., via connecting frame).

In several embodiments, the toolbar assembly 18 may be configured as a winged toolbar assembly. Specifically, as shown in FIG. 1, the toolbar assembly 18 includes a central toolbar section 22 and one or more wing toolbar sections coupled to and extending laterally (e.g., in the lateral direction L) from central toolbar section 22 (e.g., a first wing toolbar section 24 coupled to one lateral end of the central toolbar section 22 and a second wing toolbar section 26 coupled to the opposed lateral end of the central toolbar section. 22). Additionally, as shown in FIG. 1, a wing support wheel 28 may be coupled to each wing toolbar section 24, 26 (e.g., at the front of each wing toolbar section 24, 26) to support the toolbar section 24, 26 relative to the ground. In one embodiment, the wing support wheels 28 may be configured to function as gauge wheels for the wing toolbar sections 24, 26.

As is generally understood, each of the various toolbar sections 22, 24, 26 may include one or more laterally extending toolbars 30 configured to support a plurality of row units 40. For instance, in one embodiment, each row unit 40 may be coupled to its respective toolbar 30 via a four-bar linkage. In the illustrated embodiment, the row units 40 are configured as strip tillage units. As such, each row unit 40 may include one or more ground-engaging tools for working the soil in narrow strips extending in the forward direction of travel 12 of implement 10. For instance, in one embodiment, each row unit 40 may include one or more row cleaner discs, coulter discs, shanks or knives, finishing or conditioning units, and/or the like for tilling narrow strips of soil during the performance of a strip tillage operation. Additionally, each row unit 40 may also incorporate one or more components for supplying agricultural materials to the soil, such as injectors or tubes for directing agricultural material (e.g., fertilizer) supplied from a storage tank supported on the chassis assembly 16 (or from any other source) into the worked soil.

It should be appreciated that the configuration of the implement 10 described above and shown in FIG. 1 is provided only to place the present subject matter in an exemplary field of use. Thus, it should be appreciated that the present subject matter may be readily adaptable to any manner of implement configuration.

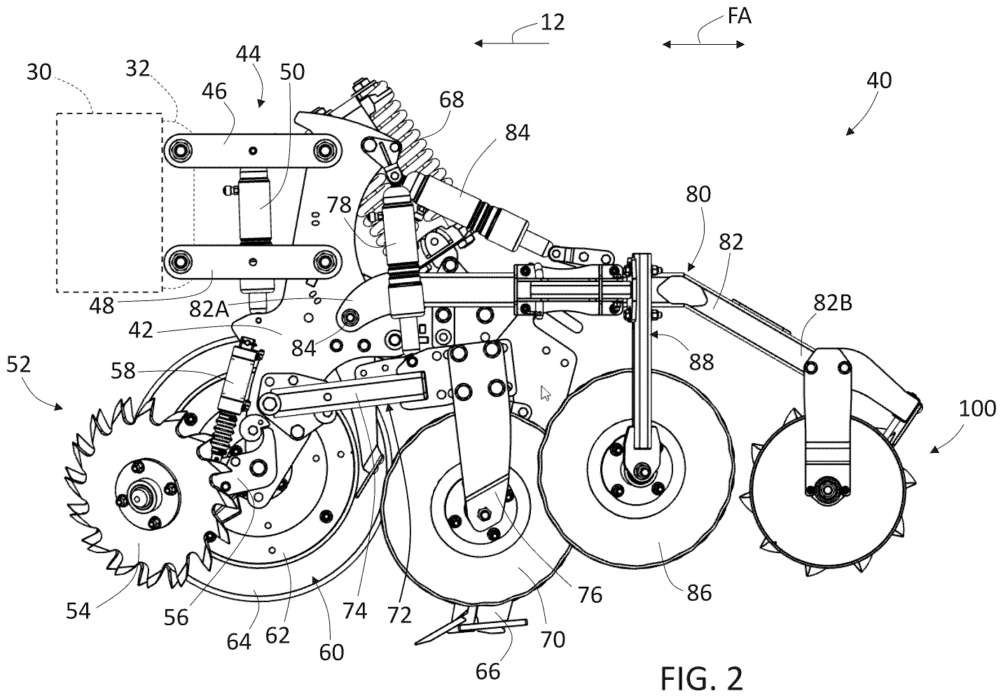

Referring now to FIG. 2, a side view of one embodiment of a row unit 40 suitable for use with the implement 10 shown in FIG. 1 is illustrated in accordance with aspects of the present subject matter. As shown, the row unit 40 includes a main frame or backbone 42 (referred to herein as simply the “frame 42” of the row unit 40) configured to be adjustably coupled to a toolbar (e.g., toolbar 30 and associated mounting bracket(s) 32) of the implement 10 via a linkage assembly 44. For example, in one embodiment, the frame 42 may be coupled to the toolbar 30 via a four-bar linkage including one or more pairs of first and second linkages 46, 48, with one end of each linkage 46, 48 being pivotably coupled to the frame 42 and the opposed end of each linkage 46, 48 being pivotably coupled to the toolbar 30 (e.g., via the associated mounting bracket(s) 32). However, it should be appreciated that, in alternative embodiments, the frame 42 of the row unit 40 may be coupled to the toolbar 30 in any other suitable manner. Additionally, the row unit 40 may include one or more downforce actuators 50 provided in operative association with the linkage assembly 44 for applying a downforce to the row unit 40. In one embodiment, the downforce actuators 50 may be passive actuators, such as air shocks or springs. Alternatively, the downforce actuators 50 may be actively controlled actuators, such as pneumatic or hydraulic cylinders.

Moreover, as shown in FIG. 2, the row unit 40 may include a plurality of ground-engaging tools coupled to and/or supported by the frame 42. For instance, in several embodiments, the row unit 40 may include a row cleaner assembly or “row cleaner” 52 positioned at the forward end of the row unit 40 relative to the forward direction of travel 12. In general, the row cleaner 52 may be configured to break up and/or sweep away residue, dirt clods, and/or the like from the travel path of the various components positioned downstream or aft of the row cleaner 52. In one embodiment, the row cleaner 52 may include a pair of row cleaner discs 54 (only one of which is shown in FIG. 2), with each disc 54 being pivotably coupled to the main frame via a respective row cleaner arm 56. As is generally understood, the row cleaner discs 54 may be toothed or spiked, such as by including a plurality of fingers or teeth extending radially outwardly from a central disc hub. As such, the discs 54 may be configured to roll relative to the soil as the implement 10 is moved across the field such that the teeth break up and/or sweep away residue and dirt clods. Additionally, as shown in FIG. 2, the row unit 40 may also include one or more row cleaner actuators 58 provided in association with the row cleaner 52. For instance, in the illustrated embodiment, the row unit 40 includes a pair of row cleaner actuators 58 (only one of which is shown in FIG. 2) configured to provide a downward biasing force against the row cleaner 52, with each row cleaner actuator 58 being coupled between the main frame 42 and a respective row cleaner arm 56. In one embodiment, the row cleaner actuators 58 may be passive actuators, such as air shocks or springs. Alternatively, the row cleaner actuators 58 may be actively controlled actuators, such as pneumatic or hydraulic cylinders.

Moreover, as shown in FIG. 2, the row unit 40 may also include a center coulter 60 positioned immediately aft of the row cleaner 52 relative to the forward direction of travel 12 of the implement 10. The center coulter 60 may generally be aligned with a longitudinal centerline of the row unit 40 such that the coulter 60 is positioned in the center of the row unit 40 relative to the lateral direction L of the implement 10 (i.e., the direction into and out of the page in FIG. 2). In one embodiment, the center coulter 60 may include a central hub 62 coupled to the main frame 42 for rotation relative thereto and a peripheral blade 64 extending radially outwardly from the hub 62 around its outer perimeter. The center coulter 60 may generally be configured to cut a slot or slit within the field along the center of the “row” being processed or formed by the row unit 40. Additionally, the center coulter 60 may also function together with the row cleaner 52 to ensure that residue and other trash is swept or moved laterally away from the travel path of further downstream components of the row unit 40. For instance, in one embodiment, as the row cleaner discs 54 rotate relative to the ground, the discs 54 may be configured to trap residue against the surface of the field. The blade 64 of center coulter 60 may then slice or cut through the trapped residue extending between the pair of row cleaner discs 54, thereby allowing the cut residue to be swept away from the longitudinal centerline of the row unit 40 via the action of the row cleaner discs 54.

Referring still to FIG. 2, in several embodiments, the row unit 40 may include a centralized shank 66 mounted to the main frame 42 at a location aft of the central hub 60 relative to the forward direction of travel 12 of the implement 10. In one embodiment, the shank 66 may generally be aligned with the center coulter 60 along the longitudinal centerline of the row unit 60 (i.e., aligned with the center coulter 60 in the longitudinal direction of the implement 10). The shank 66 may be configured to break out the soil along the lateral width of the row being formed by the row unit 40 at a location aft of the center coulter 50. For example, the shank 66 may be aligned with the blade 64 of the center coulter 60 such that the shank 66 travels through and breaks open the slit or slot cut into the soil via the center coulter 60. As shown in FIG. 2, the row unit 40 may also include one or more shank actuators 68 provided in association with the shank 66 for providing a downward biasing force thereto. For instance, in the illustrated embodiment, the row unit 40 includes a pair of shank actuators 68, with each shank actuator 68 being coupled between the main frame 42 and the shank 66. In one embodiment, the shank actuators 68 may be passive actuators, such as air shocks or springs. Alternatively, the shank actuators 68 may be actively controlled actuators, such as pneumatic or hydraulic cylinders. In alternative embodiments, the shank 66 may be replaced with a different ground-engaging tool, such as centralized knife positioned immediately aft of the center coulter 60.

Additionally, in several embodiments, the row unit 40 may include a forward or first pair of side coulter discs 70 (only one of which is shown in FIG. 2) positioned immediately aft of the center coulter 60 relative to the forward direction of travel 12, with each first side coulter disc 70 being disposed along either side of the shank 60 such that the discs 70 are spaced apart from the shank 60 in the lateral direction L of the implement 10. In one embodiment, each first side coulter disc 70 is pivotably coupled to the main frame 42 via a first side coulter mount assembly 72. For instance, as shown in FIG. 2, the side coulter arm assembly 72 includes a mounting arm 74 and a support arm 76, with the mounting arm 74 being pivotably coupled to the main frame 42 at one end and being coupled to the support arm 76 at the other end. The support arm 76 may, in turn, be coupled between the mounting arm 74 and its respective first side coulter disc 70 in a manner that allows the coulter disc 70 to rotate relative to the support arm 76 as the row unit 40 is being moved across the field. As shown in FIG. 2, the row unit 40 may also include one or more side coulter actuators 78 provided in association with the side coulters 78 for applying a downward biasing force thereto. For instance, in the illustrated embodiment, the row unit 40 includes a pair of side coulter actuators 78 (only one of which is shown in FIG. 2), with each side coulter actuator 78 being coupled between the main frame 42 and a respective coulter arm assembly 72. In one embodiment, the side coulter actuators 78 may be passive actuators, such as air shocks or springs. Alternatively, the side coulter actuators 78 may be actively controlled actuators, such as pneumatic or hydraulic cylinders.

In several embodiments, the side coulter discs 70 may function together with the central shank 66 to break out the soil along the width of the strip being worked or formed by the row unit 40. For instance, the side coulter discs 70 may be configured to “score” the soil to provide a pre-fracture at the desired width of the strip being formed. As an example, the side coulter discs 70 may be configured to run at a relatively shallow depth (e.g., 1-2 inches) to create scores or fracture lines” within the soil along the lateral edges of the row being formed. The shank 66 may, in turn, be configured to break out the hard soil across the lateral width extending between the fracture lines created by the side coulter discs 70.

Moreover, in several embodiments, the row unit 40 may include an aft frame assembly 80 coupled to the main frame 42 for supporting additional ground-engaging tools of the row unit 40. As shown in FIG. 2, the aft frame assembly 80 may include a pair of aft frame members 82 (only one of which is shown in FIG. 2) extending between a forward end 82A and an aft end 82B, with the forward end 82A of each frame member 82 being pivotably coupled to the main frame 42 at a forward pivot point 44. Each frame member 82 extends rearwardly from the pivot point 44 relative to the forward direction of travel 12 to its aft end 82B positioned adjacent to the aft end of the row unit 40. Additionally, in one embodiment, the row unit 40 may include one or more aft frame actuators 84 provided in association with the aft frame assembly 80 for providing a downward biasing force to the frame assembly 80 (and any ground-engaging tools supported thereby). For instance, in the illustrated embodiment, the row unit 40 includes a pair of aft frame actuators 84 (only one of which is shown in FIG. 2), with each aft frame actuator 84 being coupled between the main frame 42 and a respective aft frame member 82 of the aft frame assembly 80. In one embodiment, the aft frame actuators 84 may be passive actuators, such as air shocks or springs. Alternatively, the aft frame actuators 84 may be actively controlled actuators, such as pneumatic or hydraulic cylinders.

As shown in FIG. 2, in several embodiments, the aft frame assembly 80 may be configured to support an aft or second pair of side coulter discs 86 positioned aft or rearward of the forward or first pair of side coulter discs 70 (and aft of the shank 66) relative to the forward direction of travel 12, with each second side coulter disc 86 being disposed along either side of the longitudinal centerline of the row unit 40 such that the discs 86 are spaced apart from the centerline in the lateral direction L of the implement 10. In one embodiment, the second side coulter discs 86 may be configured to catch or block the soil coming off of the first side coulter discs 70 and shank 66 and redirect such soil back towards the center of the row being formed. As a result of redirecting the thrown soil back towards the center of the row, the aft or second side coulter discs 86 may function as “berm builders” to create a berm of soil along the centerline of the row unit 40. In such instance, the second side coulter discs 86 may be set to run at a relatively shallow depth (e.g., 1 inch or less) so that the coulter discs 86 can catch the soil without effectively tilling the soil. Alternatively, the second side coulter discs 86 may be set at a less shallow depth to allow the coulter discs 86 to perform shallow tillage (e.g., to widen the strip of worked soil beyond what the first side coulter discs 70 achieved) while still performing the function of directing soil into the right lateral shape to build a proper berm across the width of the row. In one embodiment, each second side coulter disc 86 is coupled to the aft frame assembly 80 via a second side coulter mount assembly 88. In one embodiment, the side coulter mount assembly 88 may be configured to allow the positioning of the second side coulter discs 86 to be adjusted relative to the other tools of the row unit 40, thereby allowing the coulter discs 86 to be set properly for performing their soil-catching function.

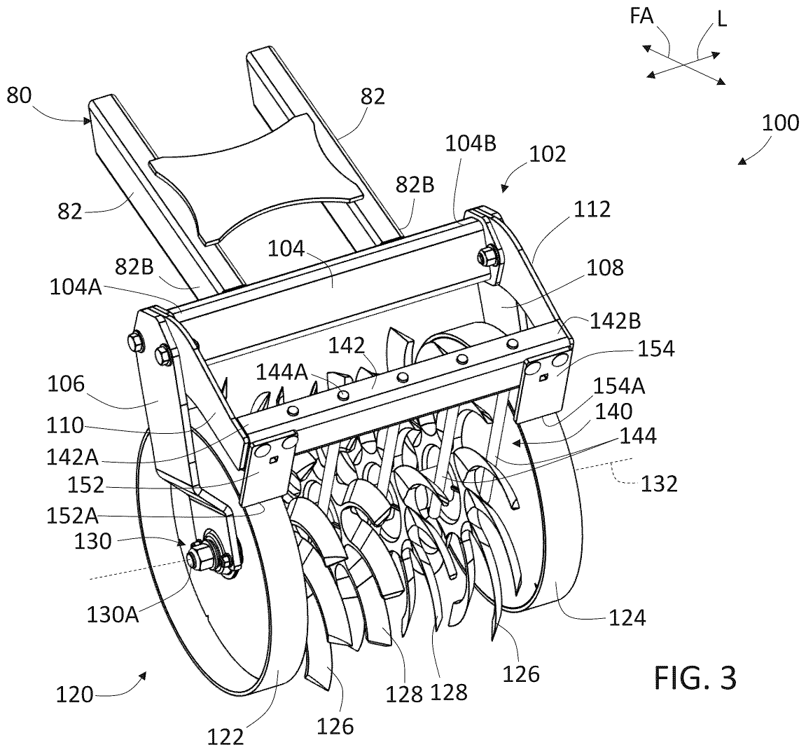

Moreover, as shown in FIG. 2, the row unit 40 may also include a finishing tool, such as a rear cultivator, positioned at the aft end of the row unit 40. Specifically, in the illustrated embodiment, the row unit 40 includes a strip conditioner 100 coupled to the aft end 82B of the aft frame assembly 80. The configuration and function of the strip conditioner 100 will generally be described below with reference to FIGS. 3-5.

It should be appreciated that the configuration of the row unit 40 described above and shown in FIG. 2 is provided only to place the present subject matter in an exemplary field of use. Thus, it should be appreciated that the present subject matter may be readily adaptable to any manner of row unit configuration.

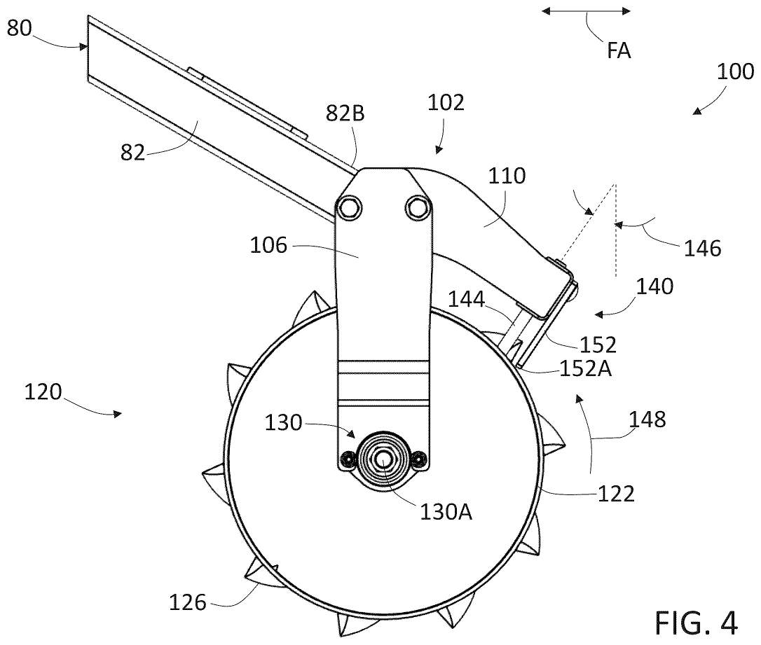

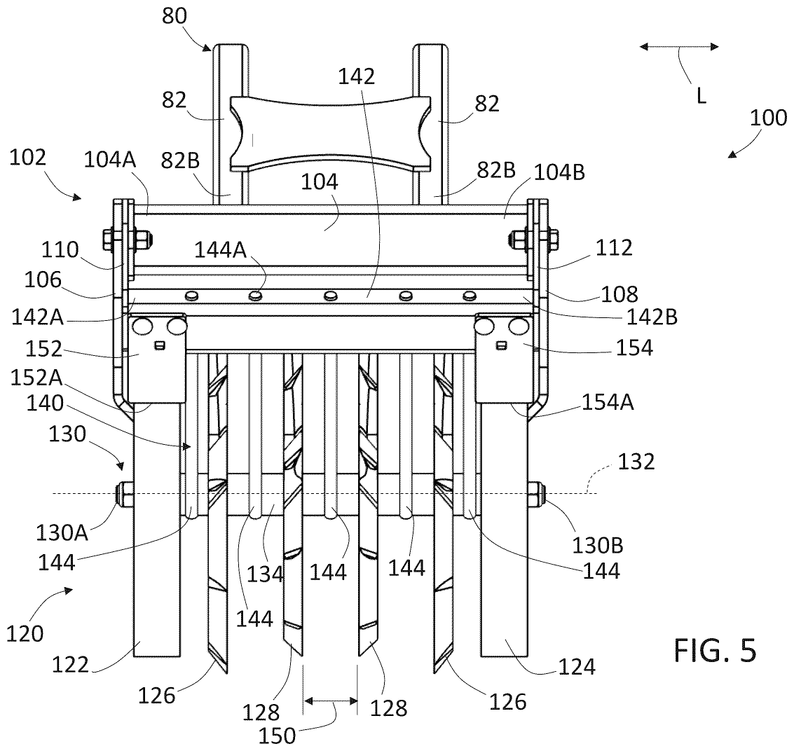

Referring now to FIGS. 3-5, several views of one embodiment of a strip conditioner 100 suitable for use with the row unit 40 described above are illustrated in accordance with aspects of the present subject matter. Specifically, FIG. 3 illustrates a perspective view of the strip conditioner 100 as installed relative to a frame of an agricultural row unit (e.g., portions of the aft frame members 82 of the aft frame assembly 80 shown in FIG. 2). Additionally, FIGS. 4 and 5 illustrate side and rear views, respectively, of the strip conditioner 100 shown in FIG. 3. For purposes of discussion, the strip conditioner 100 will generally be described herein with reference to the row unit 40 shown and described above with reference to FIG. 2. However, in other embodiments, the strip conditioner 100 may be used in association with any other suitable row unit having any other suitable row unit configuration.

In accordance with aspects of the present subject matter, the strip conditioner 100 may correspond to a finishing tool for the row unit 40 and, thus, may be positioned at the aft end of the row unit 40. In several embodiments, the strip conditioner 100 may function to reduce the clod size of the soil coming off the upstream ground-engaging tools of the row unit 40. In addition, the strip conditioner 100 may function to remove any remaining plant debris (including the root systems) from the strip or row of soil being processed by the row unit 40 and subsequently deposit such debris on top of the soil. Further, the strip conditioner 100 may also function to reduce or eliminate air pockets beneath the surface of the soil without packing or firming the soil.

In general, the strip conditioner 100 includes a conditioner frame 102 configured to support one or more conditioner tools (e.g., one or more rotating conditioner tools and/or one or more fixed condition tools). In several embodiments, the conditioner frame 102 is configured to be supported relative to the row unit 40 via one or more frames of the row unit 40, such as the aft frame assembly 80. Specifically, the illustrated embodiment, the conditioner frame 102 may be configured to be coupled to and supported by the aft ends 82B of the arms 82 of the aft frame assembly 80 (only a portion of such arms 82 being shown in FIGS. 3-5). For example, as shown in FIGS. 3-5, the conditioner frame 102 includes a lateral frame member 104 coupled to the aft ends 82B of the aft frame arms 82 (e.g., via welding or fasteners) and extending in the lateral direction L between a first frame end 104A and a second frame end 104B. Additionally, the conditioner frame 102 includes pairs of first and second support arms coupled (e.g., via fasteners) to the first and second frame ends 104A, 104B, respectively, of the lateral frame member 104 and extending outwardly therefrom for supporting one or more conditioner tools. Specifically, the first pair of support arms (e.g., a first axle support arm 106 and a second axle support arm 108) may generally be configured to support a rotary tool assembly 120 of the strip conditioner 100, while the second pair of support arms (e.g., a first rake support arm 110 and a second rake support arm 112) may generally be configured to support a rake assembly 140 of the strip conditioner 100.

As shown in FIGS. 3-5, the rotary tool assembly 120 of the strip conditioner 100 includes a pair of gauge wheels (e.g., a first gauge wheel 122 and a second gauge wheel 124) and a plurality of cultivator wheels 126, 128 (e.g., spider wheels), with the gauge wheels 122, 124 and cultivator wheels 126, 128 being supported on a common axle 128 for rotation about a rotational axis 32 (FIGS. 3 and 5) relative to the conditioner frame 102. Specifically, as shown in FIGS. 3 and 5, the axle 130 extends lengthwise between a first axial end 130A supported by the first axle support arm 106 for rotation relative thereto (e.g., via a bearing) and a second axial end 130B (FIG. 5) supported by the second axle support arm 108 for rotation relative thereto (e.g., via a bearing). As particularly shown in FIGS. 3 and 5, the gauge wheels 122, 124 are positioned interior of the axle support arms 106, 108, with the first gauge wheel 122 being coupled to the axle 130 at a location adjacent to the first axle support arm 106 and the second gauge wheel 124 being coupled to the axle 130 at a location adjacent to the second axle support arm 108. In one embodiment, the gauge wheels 122, 124 may be configured to roll across portions of the unworked soil positioned along either side of the row of worked soil created by the upstream ground-engaging tools of the row unit 40 to set the penetration depth of the associated cultivator wheels 126, 128 of the rotary tool assembly 120.

Additionally, the cultivator wheels 126, 128 may generally be configured to be spaced axially apart from one another along the portion of the axle 130 extending between the first and second gauge wheels 122, 124. For instance, in one embodiment, bushings or spacers 134 (FIG. 5) may be installed on the axle 130 between the cultivator wheels 126, 128 to evenly space the wheels 126, 128 apart between the gauge wheels 122, 124. As particularly shown in FIG. 5, in one embodiment, the set of cultivator wheels may include one or more pairs of outer wheels 126 and one or more pairs of inner wheels 128. The outer wheels 126 may generally be positioned closer to the gauge wheels 122, 124 in the lateral direction L than the inner wheels 128 and may also define larger diameters than the inner wheels 128. For instance, as shown in FIG. 5, in one embodiment, the outer wheels 126 may have a larger diameter than the gauge wheels 122, 125 such that outer wheels 126 extend radially outwardly relative to the outer peripheral surfaces of the gauge wheels 122, 124 while the inner wheels 128 may define a diameter that is equal to or smaller than the diameter of the gauge wheels 122, 124. As such, the outer wheels 126 may be configured to penetrate more deeply into the row of worked soil created by the upstream ground-engaging tools of the row unit 40. In contrast, the smaller, inner wheels 128 may allow for a more shallow pass to be made through the berm or mound of soil formed along the centerline of the row of worked soil.

It should be appreciated that, in the illustrated embodiment, the cultivator wheels 126, 128 are configured as spider wheels and, thus, generally include a central hub coupled to the axle 130 for rotation therewith and a plurality of curved radial fingers or tines extending radially outwardly from the central hub, with the tines being configured to work the soil with rotation of the wheels 126, 128 about the rotational axis 132. However, in other embodiments, the cultivator wheels 126, 128 may have any other suitable configuration that allows them to function as finishing tools for the row unit 40.

Referring still to FIGS. 3-5, the rake assembly 140 of the strip conditioner 100 may generally be configured to prevent plugging of the rotary tool assembly 120 during operation of the associated row unit 40. In several embodiments, the rake assembly 140 includes a rod support member 142 and a plurality of rake rods 144 coupled to and extending outwardly from the rod support member 142. For example, as particularly shown in FIGS. 3 and 5, the rod support member 142 extends laterally between a first lateral end 142A and a second lateral end 142B, with the first lateral end 142A of the rod support member 142 being coupled to the first rake support arm 110 of the conditioner frame 102 and the second lateral end 142B of the rod support member 142 being coupled to the second rake support arm 112 of the conditioner frame 102. Additionally, the various rake rods 144 are generally configured to extend outwardly from the rake support arm 142 such that each rod 144 is positioned in-between adjacent rotary tools of the rotary tool assembly 120. For instance, as shown in FIG. 5, the rake assembly 120 includes five rake rods 144 extending outwardly from the rod support member 142 such that: a first rake rod 144 is positioned between the first gauge wheel 122 and the adjacent outer cultivator wheel 126, a second rake rod 144 is positioned between such outer cultivator wheel 126 and the adjacent inner cultivator wheel 128, a third rake rod 144 is positioned between the inner cultivator wheels 128, a fourth rake rod 140 is positioned between the remaining outer cultivator wheel 126 and the adjacent inner cultivator wheel 128, and a fifth rake rod 140 is position between the second gauge wheel 124 and the adjacent outer cultivator wheel

In general, the rake rods 140 may be configured to break apart and clear away soil, residue, debris, and any other field materials that flow or are directed between the adjacent rotary tools of the rotary tool assembly 120, thereby preventing the plugging of the tool assembly 120. As shown in FIG. 4, the rake rods 144 extend from the rod support arm 142 at a forward tilt angle 146 (relative to a vertical direction) such that rods 144 are angled in the forward direction from the road support arm 142 towards the axle 130 of the rotary tool assembly 120. Additionally, as shown in FIG. 5, the rake rods 144 extend from the rod support arm 142 to a location vertically below the rotational axis 132 of the rotary tool assembly 120. Given such orientation/placement of the rake rods 144 relative to the rotary tool assembly 120, any soil or other field materials picked up or flowing between the rotary tools will be broken apart or swept away as the tools rotate upwards past the rods 144 (e.g., in the tool rotational direction indicated by arrow 148 in FIG. 4).

In several embodiments, to allow soil and other field materials to freely flow past the rake rods 130 at each location between the adjacent rotary tools, the rake rods 144 may be configured to define a circular cross-sectional shape (e.g., as can be seen via the ends 144A of the rake rods 144 visible in FIGS. 3 and 5 at the top end of the rod support member 142). This circular shape may help to facilitate the flow of field materials around the rods 144 as such materials are broken apart and/or diverted from the rotary tools via the rake rods 144. Additionally, in several embodiments, the diameter of each rake rod 144 may be selected based on a lateral wheel spacing 150 defined between adjacent cultivator wheels 126, 128 such that the rod diameter is significantly less than the wheel spacing 150, thereby allowing for sufficient lateral gaps to be defined between each rod 144 and the adjacent rotary tools for the flow of field materials therebetween. For instance, in one embodiment, the rod diameter of each rake rod 144 may be equal to less than 50% of the lateral wheel spacing 150 defined between adjacent cultivator wheels 126, 128 of the rotary tool assembly 120, such as less than 40% of the lateral wheel spacing 150 or less than 35% of the lateral wheel spacing 150 or less than 30% of the lateral wheel spacing 150.

Moreover, in several embodiments, the rake assembly 140 may also incorporate a pair of opposed wheel scrapers 152, 154 for scraping or removing any field materials that accumulate along the outer perimeter of the gauge wheels 122, 124. Specifically, as shown in FIG. 3-5, the rake assembly 140 includes a first scraper 152 coupled to the rod support member 142 adjacent to its first lateral end 142A and extending outwardly therefrom to a distal end 152A of the scraper 152 positioned adjacent to the outer surface of the first gauge wheel 122. Additionally, as shown in FIG. 3-5, the rake assembly 140 includes a second scraper 154 coupled to the rod support member 142 adjacent to its second lateral end 142B and extending outwardly therefrom to a distal end 154A of the scraper 154 positioned adjacent to the outer surface of the second gauge wheel 124. As such, mud, residue, and/or any other field materials accumulating along the outer surfaces of the gauge wheels 122, 124 may be removed therefrom.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A strip conditioner for an agricultural row unit, the strip conditioner comprising:
a conditioner frame configured to be supported relative to a row unit;
a rotary tool assembly coupled to the conditioner frame for rotation relative thereto, the rotary tool assembly comprising a plurality of cultivator wheels spaced apart from one another;
a rake assembly supported by the conditioner frame relative to the rotary tool assembly, the rake assembly comprising:
a rod support member coupled to the conditioner frame; and
a plurality of rake rods coupled to the rod support member, each rake rod extending from the rod support member to a location between a respective pair of adjacent of rotary tools of the plurality of rotary tools;
wherein each rake rod of the plurality of rake rods defines a circular cross-sectional shape.

2. The strip conditioner of claim 1, wherein the conditioner frame comprises a frame member and one or more pairs of support arms extending from the frame member to support at least one of the rotary tool assembly or the rake assembly.

3. The strip conditioner of claim 2, wherein the one or more pairs of support arms comprises a first pair of support arms and a second pair of support arms, the first pair of support arms comprising first and second rotary tool support arms coupled between the frame member and the rotary tool assembly, the second pair of support arms comprising first and second rake support arms coupled between the frame member and the rake assembly.

4. The strip conditioner of claim 3, wherein the rotary tool assembly further comprises first and second gauge wheels, the plurality of cultivator wheels being spaced apart from one another between the first and second gauge wheels, with the first and second gauge wheels being positioned inboard of the first and second rotary tool support arms along a rotational axis of the first and second gauge wheels.

5. The strip conditioner of claim 1, wherein the plurality of cultivator wheels comprises one or more pairs of outer wheels and one or more pairs of inner wheels, wherein the outer wheels define a larger diameter than the inner wheels.

6. The strip conditioner of claim 1, wherein each of the plurality of cultivator wheels is configured as a spider wheel.

7. The strip conditioner of claim 1, wherein the rotary tool assembly further comprises first and second gauge wheels, the plurality of cultivator wheels being spaced apart from one another between the first and second gauge wheels.

8. The strip conditioner of claim 7, wherein the rake assembly further comprises first and second wheel scrapers coupled to the rod support member, the first wheel scraper having a distal end positioned adjacent to the first gauge wheel and the second wheel scraper having a distal end positioned adjacent to the second gauge wheel.

9. The strip conditioner of claim 1, wherein the plurality of rake rods extend in a forward direction from the rod support member at a non-vertical tilt axis.

10. An agricultural row unit, comprising:
a main frame;
a plurality of ground-engaging tools coupled to the main frame;
an aft frame assembly coupled to the main frame and extending outwardly therefrom to an aft end of the aft frame assembly; and
a strip conditioner supported relative to the aft frame assembly, the strip conditioner comprising:
a conditioner frame coupled to the aft end of the aft frame assembly;
a rotary tool assembly coupled to the conditioner frame for rotation relative thereto, the rotary tool assembly comprising a plurality of rotary tools, the plurality of rotary tools comprising:
first and second gauge wheels; and
a plurality of cultivator wheels spaced apart from one another between the first and second gauge wheels;
a rake assembly supported by the conditioner frame relative to the rotary tool assembly, the rake assembly comprising:
a rod support member coupled to the conditioner frame; and
a plurality of rake rods coupled to the rod support member,
each rake rod extending from the rod support member to a location between a respective pair of adjacent rotary tools of the plurality of rotary tools;
wherein each rake rod of the plurality of rake rods defines a circular cross-sectional shape.

11. The agricultural row unit of claim 10, wherein the conditioner frame comprises a frame member and one or more pairs of support arms extending from the frame member to support at least one of the rotary tool assembly or the rake assembly.

12. The agricultural row unit of claim 11, wherein the one or more pairs of support arms comprises a first pair of support arms and a second pair of support arms, the first pair of support arms comprising first and second rotary tool support arms coupled between the frame member and the rotary tool assembly, the second pair of support arms comprising first and second rake support arms coupled between the frame member and the rake assembly.

13. The agricultural row unit of claim 12, wherein the rotary tool assembly further comprises first and second gauge wheels, the plurality of cultivator wheels being spaced apart from one another between the first and second gauge wheels, with the first and second gauge wheels being positioned inboard of the first and second rotary tool support arms along a rotational axis of the first and second gauge wheels.

14. The agricultural row unit of claim 10, wherein the plurality of cultivator wheels comprises one or more pairs of outer wheels and one or more pairs of inner wheels, wherein the outer wheels define a larger diameter than the inner wheels.

15. The agricultural row unit of claim 10, wherein each of the plurality of cultivator wheels is configured as a spider wheel.

16. The agricultural row unit of claim 10, wherein the rake assembly further comprises first and second wheel scrapers coupled to the rod support member, the first wheel scraper having a distal end positioned adjacent to the first gauge wheel and the second wheel scraper having a distal end positioned adjacent to the second gauge wheel.

17. The agricultural row unit of claim 10, wherein the plurality of rake rods extend in a forward direction from the rod support member at a non-vertical tilt axis.
